(19) United States
(12) Patent Application Publication
(10) Pub. No.: US 2018/0178149 A1
(43) Pub. Date: Jun. 28, 2018

(54) MULTI-LAYER FILTER FABRIC

(71) Applicant: PRECISION CUSTOM COATINGS, LLC, Totowa, NJ (US)

(72) Inventors: Peter Longo, Saddle River, NJ (US); Aneta Konior, Oak Ridge, NJ (US); Gary Narayan, Pompton Lakes, NJ (US)

(73) Assignee: PRECISION CUSTOM COATINGS, LLC, Totowa, NJ (US)

(21) Appl. No.: 15/842,374

(22) Filed: Dec. 14, 2017

Related U.S. Application Data
(60) Provisional application No. 62/438,166, filed on Dec. 22, 2016.

(51) Int. Cl. B01D 39/16; B32B 5/02; B32B 5/26; B32B 7/02

(52) U.S. Cl. CPC B01D 39/1623; B32B 5/022; B32B 5/26; B32B 7/02; B32B 2262/0253; B01D 2239/0618; B01D 2239/065; B01D 2239/0208; B01D 2239/0216; B01D 2239/0442; B01D 2239/0407; B32B 2262/0276

(57) ABSTRACT

A multi-layer filter fabric includes a first layer that includes a first non-woven fabric and a second layer that includes a second non-woven fabric. Each layer may include multiple webs. The first and second layers have different median pores sizes and porosities, with the first layer having a larger median pore size and/or porosity than the second layer. The first and second layers may be separated by a scrim. The first and second layers are colored or have visible markings such that the first and second layers are readily distinguished from each other. The multi-layer filter fabric is arranged so that a fluid may enter the multi-layer filter fabric through the first layer and exit through the second layer.

### CROSS-REFERENCE TO RELATED APPLICATIONS

The present application claims the benefit of U.S. Provisional Patent Application No. 62/438,166, which was filed on Dec. 22, 2016, and is incorporated by reference herein in its entirety.

### TECHNICAL FIELD OF THE INVENTION

The present invention relates to the field of filter fabrics, more specifically to filter fabrics having layers of non-woven fabrics of differing median pore sizes.

### BACKGROUND OF THE INVENTION

Filter fabrics are used to recover particulate materials from streams of air or other gasses, or liquids. For air filtration, the performance of the filter fabric may be reported under the Minimum Efficiency Reporting Value (MERV) standard, which rates the overall effectiveness of air filters. A higher value MERV rating equates to finer filtration, meaning fewer dust particles and other airborne contaminants can pass through the filter. In a conventional filter fabric, the fabric has a narrow range of pore sizes throughout its thickness. The capture of fine particles requires that such filters be thick and/or have small pores. Reducing the pore size or increasing the thickness of a fabric increases the pressure drop across the fabric, making it necessary to operate the filtration system at higher pressures. Further, fabrics having smaller pore sizes have a lower capacity for retaining particulate matter compared to fabrics having larger pore sizes.

### SUMMARY OF THE INVENTION

A filter fabric according to embodiments of the present invention has at least two layers of filtration material. The layers may be made of different denier blends to create layers of non-woven materials. In an embodiment, the filter fabric has an inlet side and an outlet side, such that the fluid to be filtered enters the fabric at the inlet side and exits the fabric at the outlet side. In an embodiment, the outermost layer of filtration material at the inlet side has pores of a larger median size than the pores in the outermost layer of filtration material at the outlet side, such that coarser particles are captured in the layers nearest the inlet side of the filter fabric, and finer particles are captured in the layers nearest the outlet side of the filter fabric. In an embodiment, the outermost layer of filtration material at the inlet side has a porosity that is greater than the porosity of the outermost layer of filtration material at the outlet side

In an embodiment, at least one of the outermost layers of the filter fabric is colored or otherwise marked so that the inlet side of the filter fabric can be readily distinguished from the outlet side of the filter fabric. In an embodiment, one or both of the outermost layers of the multi-layer filter fabric include colored fibers.

Embodiments of the multi-layer filter fabric of the present invention have uses in commercial and residential air ventilation systems, industrial processes involving gases, industrial processes involving liquids, water treatment, and waste recycling. Fluids that may be filtered using a multi-layered filter fabric of the present invention include, without limitation, air and other gases, fuels, mineral oils, food-grade oils, water, aqueous solutions, aqueous suspensions, organic fluids, heat transfer fluids, and liquid wastes.

### BRIEF DESCRIPTION OF THE FIGURES

For a more complete understanding of the present invention, reference is made to the following detailed description of exemplary embodiments considered in conjunction with the accompanying drawings, in which:

FIG. 1 is a schematic diagram of an exemplary multi-layer filter fabric according to an embodiment of the present invention.

### DETAILED DESCRIPTION OF THE INVENTION

In an embodiment of the present invention, a multi-layer filter fabric has multiple layers of fibrous fabric. In an embodiment, the multi-layer filter fabric has at least two layers of fibrous fabric; at least three layers of fibrous fabric; at least four layers of fibrous fabric; at least five layers of fibrous fabric; or more than five layers of fibrous fabric. In an embodiment, a layer of fibrous fabric includes a plurality of webs, such as the type of web that comes out of a card used to form a non-woven fabric. In an embodiment, one or more of the webs is a non-woven fabric. In an embodiment, the number of webs in a layer is in the range of two to ten webs. In an embodiment, the multi-layer filter fabric includes a scrim between two layers of fibrous fabric. In an embodiment, the multi-layer filter fabric includes at least one scrim, each scrim being adjacent to a layer of fibrous fabric. In an embodiment, the multi-layer filter fabric does not include a scrim. In an embodiment, a scrim is a fabric of the type used to improve the strength and/or performance of a composite fabric, or to add special performance characteristics to the fabric. In an embodiment, the scrim may provide antimicrobial and/or antifungal properties to a composite fabric. In an embodiment, at least one of the fibrous layers of the multi-layer filter fabric includes a woven textile. In an embodiment, at least one of the fibrous layers of the multi-layer filter fabric includes a non-woven textile.

In an embodiment of the present invention, each layer of fibrous fabric in the multi-layer filter fabric has a plurality of pores, each plurality of pores having pores with sizes within a range of pore sizes, each plurality of pores having a median pore size. In an embodiment, the filter fabric has a first outermost layer and a second outermost layer opposite the first outermost layer. In an embodiment, the median pore size of the pores in the first outermost layer is larger than the median pore size in the second outermost layer. In the present disclosure, the first outermost layer is also referred to as an “inlet layer” and its exposed face as “the inlet side”, and the second outermost layer is also referred to as an “outlet layer” and its exposed face as “the outlet side”.

In an embodiment of the present invention, the median pore size of a layer of fibrous fabric is controlled by selection of the diameter or denier of the fibers in its component webs and by the density of fibers in the layer of fibrous fabric, which for the purpose of the present disclosure is an expression of the number of fibers in a unit volume of the layer of fibrous fabric. In an embodiment of the present invention, the porosity of a layer of fibrous fabric is also controlled by selection of the diameter or denier of the fibers in its component webs and by the density of fibers in the layer of fibrous fabric. In the present disclosure, the porosity of a layer of fibrous fabric is the percent of the total volume of the fibrous fabric that is occupied by pores, channels, or spaces through which fluids (i.e., gasses or liquids) may pass.

In an embodiment of the present invention, the fibers in a layer of fibrous fabric have weights in the range of about 0.4 denier to about 100 denier. The denier and density of the fibers in each of the layers of fibrous fabric are selected based on the performance criteria for the specific embodiment of multi-layer filter fabric. In an embodiment, a layer of fibrous fabric includes a blend of fibers having different denier. Methods of selecting denier and density of fibers to achieve a selected pore size and/or porosity are known in the art. For the purpose of the present disclosure, fibers having weights of 0.9 denier and less are considered to be nanofibers.

In an embodiment, the fibers used in the layers of fibrous fabric include one or more synthetic polymers. Exemplary synthetic fibers include, without limitation, polyethylene, polypropylene, polyester, and blends of synthetic fibers. In an embodiment, the fibers include bicomponent fibers, such as polyethylene/polypropylene bicomponent fibers and polyethylene/polyester bicomponent fibers and other polyester bicomponent fibers. In an embodiment, the fibers include fibers of the types used as binders in thermally bonded fabrics. In an embodiment, the fibers have cross-sections that are trilobal, round, or irregular, or other cross-sectional shapes that are found in textile fibers. In an embodiment, the layers of fibrous fabric include blends of fibers having different denier or different materials. In an embodiment, the selection of materials for the fibers and blends of the fibers is based on the performance criteria and expected operating conditions for the specific embodiment of multi-layer filter fabric, which may include, without limitation, chemical and heat-resistance, resistance to abrasion, and mechanical strength. Methods of selecting suitable fiber materials and blends of fibers to meet performance criteria for filter fabric are known in the art.

In an embodiment of the present invention, the multi-layer filter fabric has a weight in the range of about 0.5 ounces per square yard (“osy”) to about 36 osy. In an embodiment, the multi-layer filter fabric has a weight that is greater than 36 osy. In an embodiment, a multi-layer filter fabric of a known weight is selected to meet the performance requirements and expected operating conditions of the specific embodiment. Factors which may be considered in making the selection include the required mechanical strength of the fabric and/or the expected particulate load to be retained by the filter fabric.

In an embodiment of the present invention, the multi-layer filter fabric has a thickness in the range of about 0.005 inch to about 3.8 inches. In an embodiment, individual layers of fibrous fabric in the multi-layer filter fabric have thicknesses in the range of about 0.002 inch to about 3.8 inches. The selection of the thicknesses of the multi-layer filter fabric and the individual layers of fibrous fabric depends on the expected use of the multi-layer filter fabric. Factors which may be considered in making the selection include the required mechanical strength of the filter fabric, the desired pressure drop across the filter fabric, and/or the expected particulate load to be retained by the filter fabric. These factors may also affect the selection of the desired porosity of the layers of the multi-layered filter fabric.

In an embodiment of the present invention, the inlet side and/or the outlet side is visibly marked such that the inlet side of the multi-layer filter fabric can be readily distinguished from the outlet side of the multi-layer filter fabric. In an embodiment, the inlet side or outer side is marked with an identifying pattern. In an embodiment, the inlet side or the outlet side is marked with an identifying color. In an embodiment, colored fibers are included in the inlet layer or the outlet layer. In an embodiment, all of the fibers in the inlet layer or outlet layer are colored fibers. In an embodiment, the inlet side and/or the outlet side are marked by screening or spraying a color or pattern onto the exposed face of the layer.

In an embodiment of the present invention, air or other fluids to be filtered enter the multi-layer filter fabric at the inlet side of the multi-layer filter fabric, and exit at the outlet side of the multi-layer filter fabric. Layers of fibrous fabric which have larger median pore sizes, as does the inlet layer, capture coarser particles, and allow finer particles to pass. Such layers may also have greater porosities, which allow the layers to retain a greater amount of particles than do layers with smaller median pore sizes or porosities, resulting in smaller pressure drops across the layer, thus causing smaller amounts of back pressure. In contrast, layers of fibrous fabric which have smaller median pore sizes, such as the outlet layer captures finer particles, but may retain smaller amounts of particles, and present higher pressure drops and back pressures. In embodiments of the present invention, the median pore sizes of a layer of fibrous fabric may be in the range of about 0.010 micron to about 1.0 micron. Median pore sizes outside of this range may also be achieved by selection of fiber weights, fiber lengths, and fiber densities.

Combining multiple layers of fibrous fabric having different median pore sizes in embodiments of the present invention provides higher overall retention of particles with lower pressure drops and less back pressure than is realized in conventional single-layer filter fabrics having comparable MERV ratings. Embodiments of the present invention achieve an MERV rating of 8 and greater using unfinished fibers. In an embodiment, a finish or other material is used to increase the MERV rating of the multi-layer filter fabric.

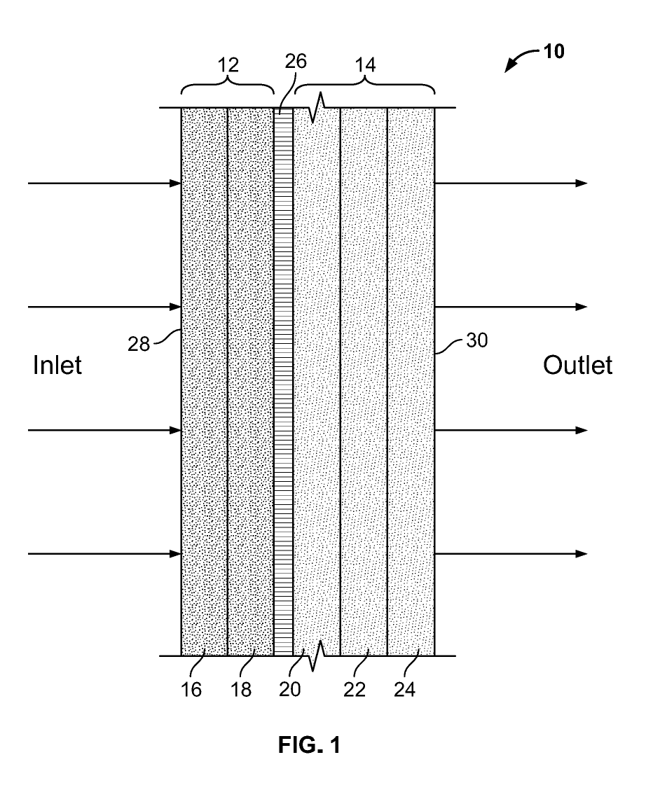

FIG. 1 is a schematic illustration of an exemplary embodiment of a multi-layer filter fabric 10 according to the present invention. The illustration is not to scale, and is merely presented to aid in understanding the relationships between the various elements of the filter fabric 10.

In the exemplary embodiment of FIG. 1, the filter fabric 10 has two layers 12, 14, more specifically, the inlet layer 12 and the outlet layer 14. The inlet layer 12 includes two webs 16, 18, and the outlet layer 14 includes three webs 20, 22, 24. A scrim 26 is present between the inlet layer 12 and the outlet layer 14. Other numbers and arrangements of layers and webs may be used in other embodiments of a multi-layer filter fabric of the present invention, as is discussed elsewhere in the present disclosure, and the inclusion of a scrim is optional. In the exemplary embodiment of FIG. 1, the layers 12, 14 are non-woven fabrics of synthetic fibers and include bicomponent polyethylene/polypropylene fibers.

In the exemplary embodiment of the present invention shown schematically in FIG. 1, air enters the multi-layer filter fabric 10, as indicated by arrows, at an inlet side 28 of the filter fabric 10 and exits the filter fabric 10, as indicated by arrows, at an outlet side 30 of the filter fabric 10. In the exemplary embodiment, the webs 16, 18 are formed from colored fibers (e.g., green fibers) having a weight of 5.9 decitex (dtex) and lengths of 51 mm (i.e., 5.9 dtex×51 mm). In the exemplary embodiment of FIG. 1, each of the webs 20, 22, 24 are formed from a blend of 80% white fibers having a weight of 5.9 dtex and length of 51 mm (i.e., 5.9 dtex×51 mm) and 20% white fibers having a weight of 1.7 dtex and a length of 40 mm (i.e., 1.7 dtex×40 mm). The inclusion of lower-weight fibers in the webs 20, 22, 24 provide the layer 14 with median pore sizes that are smaller than the median pore sizes of the layer 12, allowing the layers 14 to capture smaller particles that would pass through the layer 12.

The use of colored fibers in the layer 12 and white fibers in the layer 14 provides a readily-identifiable indication of the inlet side 28 of the filter fabric 10, which is colored, and the outlet side 30 of the filter fabric 10, which is white. In modifications and variations of the embodiment of FIG. 1, fibers having different weights and lengths than those described, and/or in different proportions than those described, may be used to provide selected porosities to the layers 12, 14. Different colors may be used than those described, or the inlet side 28 and outlet side 30 of the filter fabric 10 may be marked by patterns screened onto the inlet side 28 and/or outlet side 30, or may be marked by methods other than screening. A multi-layer filter fabric according to the design of FIG. 1 can achieve an MERV rating of 8 or greater.

A representative thickness of the filter fabric 10 is in the range of about 0.100 inch to about 0.130 inch, with layer 12 having a thickness in the range of about 0.030 inch to about 0.040 inch, and the layer 14 having a thickness of about 0.070 inch to about 0.090 inch. A representative weight of the filter fabric 10 is about 3.00 osy, with the layer 12 having a weight of about 1.00 osy, and the layer 14 having a weight of about 2.00 osy.

The exemplary embodiment of FIG. 1 is formed in a one-pass process. Webs 16, 18 come out of a first carding machine, and are layered one upon the other, forming the non-woven layer 12. The scrim 26 is then laid onto layer 12. Webs 20, 22, 24 come out of a second carding machine, and are layered onto the scrim to form the non-woven layer 14. In variations on the one pass process, one or more of the webs 16, 18, 20, 22, 24 may be cross-lapped. In other methods of forming a multi-layer filter fabric according to the present invention, each of the webs 16, 18, 20, 22, 24 and the scrim 26 are thermally-bonded to the webs adjacent to them. In a variation of the embodiment of FIG. 1, the layer 12 and the layer 14 are formed in separate passes, and laminated with the scrim 26 between them.

Other methods of fabricating a multi-layer fabric are known in the art for woven and non-woven textiles. Such methods may readily be adapted to form a multi-layer filter fabric of the present invention by a person having ordinary skill in the art. Methods of joining one layer to another, or to a scrim, include, but are not limited to, thermal bonding, gluing, needle punching, stitching, and other methods known in the art.

The exemplary embodiment of FIG. 1 achieves a MERV rating of 8 using unfinished fibers and no additives. In embodiments of the present invention, the fibers may be finished by adding a chemical finish to the multi-layer filter fabric. Such finishes are known in the art, although the use of novel and inventive proprietary finishes that may be developed in the future may also be within the scope of the present invention. A finish may be screened onto the fabric or sprayed onto the fabric. It is noted that a spray finish may diminish the performance of a multi-layer filter fabric by increasing pressure drop across the fabric and increasing the resulting back pressure. The possibility of such a result may be provided for when designing a multi-layer filter fabric for a specific use.

In embodiments of the present invention, the multi-layer filter fabric may include microparticles and/or nanoparticles. An objective of including microparticles and/or nanoparticles is to improve the capture of particulates from the air stream passing through the filter fabric. Microparticles and nanoparticles useful for the present invention may be made of the same materials suitable for use in the fibers of the fibrous layers, or may include other materials, such as, without limitation, carbon, minerals, or resins. The microparticles and/or nanoparticles may be screened or sprayed onto the layers of fibrous fabric during fabrication of the multi-layer fiber fabric. The microparticles and/or nanoparticles may be included within the layers of fibrous fabric and/or on one or both faces of the multi-layer fabric. For the purpose of the present disclosure, a particle having at least one dimension of 100 nanometers or less is considered to be a nanoparticle.

In embodiments of the present invention, the multi-layer filter fabric may include additives other than, or in addition to, the microparticles and/or nanoparticles described above. Such additives may include, without limitation, thermoplastics, resins, fillers, antimicrobials, antifungals, coloring agents, and other additives known in the textile industry.

It should be understood that the embodiments described herein are merely exemplary in nature and that a person skilled in the art may make many variations and modifications thereto without departing from the spirit and scope of the present invention. All such variations and modifications, including those discussed above, are intended to be included within the scope of the invention as described in the appended claims

We claim:

1. A multi-layer filter fabric, comprising a first layer including a first non-woven fabric and a second layer including a second non-woven fabric, said first layer having a first plurality of pores, said second layer having a second plurality of pores, said first plurality of pores having a first median pore size, said second plurality of pores having a second median pore size, wherein said first median pore size is greater than said second median pore size.

2. The multi-layer filter fabric of claim 1, wherein said first layer has a first porosity, said second layer has a second porosity, and said first porosity is greater than said second porosity.

3. The multi-layer fabric of claim 1, wherein said first layer includes a plurality of first webs, and at least one of said first webs includes said first non-woven fabric.

4. The multi-layer fabric of claim 1, wherein said second layer includes a plurality of second webs, and at least one of said second webs includes said second non-woven fabric.

5. The multi-layer filter fabric of claim 1, wherein said multi-layer filter fabric is arranged so that a fluid enters said multi-layer filter fabric through said first layer, and exits said multi-layer filter fabric through said second layer.

6. The multi-layer filter fabric of claim 5, wherein said first layer has one or both of a first color and/or a first marking, and said second layer has one or both of a second color and a second marking such that said second layer is visibly distinguished from said first layer.

7. The multi-layer filter fabric of claim 6, wherein said first layer includes a plurality of first fibers having said first color.

8. The multi-layer filter fabric of claim 6, wherein said second layer includes a plurality of second fibers having said second color.

9. The multi-layer filter fabric of claim 1, further including a scrim between said first layer and said second layer.

10. The multi-layer filter fabric of claim 1, wherein said first non-woven fabric and/or said second non-woven fabric includes fibers selected from the group consisting of polyethylene fibers, polypropylene fibers, polyester fibers, synthetic fibers, bicomponent fibers, and blends thereof.

11. The multi-layer filter fabric of claim 1, wherein said first non-woven fabric and/or said second non-woven fabric includes fibers having weights in the range of 0.4 denier to 100 denier.

12. The multi-layer filter fabric of claim 1, wherein said first non-woven fabric and/or said second non-woven fabric includes a blend of fibers having different weights in the range of 0.4 denier to 100 denier.

13. The multi-layer filter fabric of claim 1, wherein the multi-layer filter fabric has a weight in the range of 0.5 ounces-per-square-yard to 36 ounces-per-square yard.

14. The multi-layer filter fabric of claim 1, wherein the multi-layer filter fabric has a thickness in the range of 0.005 inch to 3.8 inches.

15. The multi-layer filter fabric of claim 1, wherein the multi-layer filter fabric consists of said first layer and said second layer, and optionally a scrim, and has an MERV rating of 8 or greater.

16. The multi-layer filter fabric of claim 1, further comprising a finish on said multi-layer filter fabric.

17. The multi-layer filter fabric of claim 1, further comprising microparticles and/or nanoparticles of a material selected from the group consisting of a synthetic polymer, carbon, minerals, resins, and mixtures thereof.

18. The multi-layer filter fabric of claim 17, wherein said microparticles and/or said nanoparticles are within said first non-woven fabric and/or said second non-woven fabric.

19. The multi-layer filter fabric of claim 1, wherein said multi-layer filter fabric includes an additive selected from the group consisting of thermoplastic materials, resins, fillers, antimicrobials, antifungals, coloring agents, and other additives known for use in textiles.

20. The multi-layer filter fabric of claim 19, wherein said additive is within said first non-woven fabric and/or said second non-woven fabric.
